(19) United States
(12) Patent Application Publication
(10) Pub. No.: US 2014/0130768 A1
(43) Pub. Date: May 15, 2014

(54) DECORATIVE COVER PLATE APPARATUS

(71) Applicant: Duane F. Kramer, Billings, MT (US)

(72) Inventor: Duane F. Kramer, Billings, MT (US)

(21) Appl. No.: 13/678,383

(22) Filed: Nov. 15, 2012

(51) Int. Cl. F02B 77/00

(52) U.S. Cl. CPC F02B 77/00
USPC 123/198 E

(57) ABSTRACT

A decorative cover plate apparatus comprising a mounting bracket, a cover box, and a decorative plate. The mounting bracket has a vertical post, two horizontal arms, each with as aperture in roughly the center of the horizontal arm, and top and bottom tabs. The horizontal centerline of the horizontal arms intersects the vertical centerline of the vertical post perpendicularly at a point on the vertical post centerline that is between the middle and the top of the vertical post. The cover box has a top attachment slot and an open back. The decorative plate has an overhanging lip and it at least as wide and as high as the cover box. The top tab of the mounting bracket fits into the top attachment slot on the cover box.

### BACKGROUND OF THE INVENTION

1. Field of the Invention

The present invention relates to the field of decorative covers, and more particularly, to an apparatus that serves as a decorative cover over an unused port such as a fuel pump port on an automobile engine.

2. Description of the Related Art

There are several examples of decorative cover designs and one example of temporary engine component covers that are the subject of issued patents or published applications, but none of these inventions includes the novel features of the present invention, most notably:
a mounting bracket that attaches to the engine block using the existing cover plate bolts;
a cover box that effectively covers unsightly bolt heads and flat sealing plates, thereby hiding them from view;
a specialized outer shape of the cover box and decorative plate that allows for an oversized decorative portion of the apparatus that does not contact portions of the engine;
a mounting box/decorative plate assembly that may easily be exchanged with other assemblies having other decorative designs without removing the flat plate attachment bolts; and
a mounting box/decorative plate assembly that may easily be removed or exchanged with another assembly from the underside of the engine compartment using only a screwdriver.

Examples of other decorative covers include: U.S. Pat. No. D203,015 (Avrea, 1965) (ornamental design of a power take-off cover): U.S. Pat. No. D275,471 (Stahel, 1984) (ornamental design of a motorcycle fuel pump cover); U.S. Pat. No. D279,663 (Stahel, 1985) (ornamental design of a lower fuel pump cover); U.S. Pat. No. D291,188 (Stahel, 1987) (ornamental design of a motorcycle fuel pump); and U.S. Pat. No. D591,769 S (Chung, 2009) (ornamental design of an automobile engine breather).

U.S. Patent Application Pub. No. 2005/0252481 A1 (Garner, 2005) is a patent application that discloses temporary component covers for automobile engines. The covers serve to block openings into the engine block that are exposed when components (e.g., carburetor, fuel pump, distributor, etc.) are temporarily removed from the engine during the service work. The purpose of the temporary covers is to prevent foreign debris from accidently falling into or otherwise entering into the engine block through the openings while the components are removed. The covers are made in various sizes to cover a variety of opening sizes. The larger cover pieces (e.g., cylinder head opening covers) are generally in the form of flat sheets that comprise integral flexible studs on the underside, wherein the studs can be pushed into bolt holes in the engine block to hold the cover in place. The smaller covers (e.g., distributor opening covers) are in the form of flexible plugs that are inserted into the openings in which the components normally fit.

In addition to issued and pending patents, there are numerous non-patented devices designed to cover unused engine ports that are currently commercially available. Examples of these devices include products called “fuel pump block-off plates” sold by Summit Racing Company of Tallmadge, Ohio. Although these and other similar commercially available products are available with simple ornamental designs, none of them is capable of hiding the exposed bolt heads of the attachment bolts that hold them in place, and none is specifically configured to clear the adjacent engine cylinder head and accommodate an oversized decorative plate.

### BRIEF SUMMARY Of THE INVENTION

The present invention is a decorative cover plate apparatus comprising: a mounting bracket having a right side and a left side, comprising a vertical post and a horizontal arm extending from the right side and a horizontal arm extending from the left side, each horizontal arm having a center, and each horizontal arm having an aperture in roughly the center of the horizontal arm, the vertical post having a middle, a top, and a vertical centerline, each of the horizontal arms having a horizontal centerline, wherein the horizontal centerline of the horizontal arms intersects the vertical centerline of the vertical post perpendicularly at a point on the vertical post centerline that is between the middle and the top of the vertical post, the mounting bracket further comprising a top tab and a bottom tab; a cover box comprising a top attachment slot and having an open back; and a decorative plate comprising an overhanging lip, the decorative plate being at least as wide as she cover box and at least as high as the cover box; wherein the top tab of the mounting bracket fits into the top attachment slot on the cover box.

In one embodiment, the top tab of the mounting bracket is formed by a first ninety-degree bend that produces a horizontal portion and a second ninety-degree bend that forms an upward-pointing tip, and the bottom tab of the mounting bracket is formed by a first ninety-degree bend that produces a horizontal portion and a second ninety-degree bend that forms an upward-pointing tip, and wherein the horizontal portion of the bottom tab comprises a hole. Preferably, the upward-pointing tip of the bottom tab of the mounting bracket fits into a bottom attachment slot on the cover box. In an alternate embodiment, the top tab is formed by a first ninety-degree bend that produces a horizontal portion and a second ninety-degree bend that forms a downward-pointing tip, the bottom tab of the mounting bracket is formed by a ninety-degree bend that produces a horizontal portion, and the horizontal portion of the bottom tab comprises a hole. Preferably, the cover box has a bottom surface, and the horizontal portion of the bottom tab of the mounting bracket fits inside the bottom surface of the cover box.

In a preferred embodiment, the cover box is hexagonal in shape. Preferably, the cover box has a depth of at least ¾-inch. The cover box and decorative plate are preferably permanently bonded together.

In a preferred embodiment, the decorative plate further comprises an embossed design. Preferably, the cover box has a bottom surface with a hole that is situated so as to align with the hole in the horizontal portion of the bottom tab of the mounting bracket when the decorative plate apparatus is fully assembled.

### BRIEF DESCRIPTION OF THE DRAWINGS

FIG. 1 is a perspective view of the first embodiment of the present invention shown fully assembled.

FIG. 2 is an exploded perspective view of the first embodiment of the present invention showing the major components.

FIG. 3 is an exploded perspective view of the second embodiment of the present invention showing the major components

FIG. 4 is a front view of the first embodiment of a mounting bracket that is attached to a flat cover plate that is normally held in place by four attachment bolts.

FIG. 5 is a front view of the first embodiment of a mounting bracket that is attached to a flat cover plate that is normally hold in place by a single attachment bolt.

FIG. 6 is a cross-section side view of the first embodiment of the invention shown attached to an unused fuel pump port that has been blocked off by a flat cover plate.

FIG. 7 is a cross-section side view of the second embodiment of the invention shown attached to an unused fuel pump port that has been blocked off by a flat cover plate.

FIG. 8 is a cross-section side view of the first embodiment of the present invention shown attached a portion of the engine block that does not require a flat cover plate in order to block off an unused port.

FIG. 9 is a cross-section side view of the second embodiment of the present invention shown attached a portion of the engine block that does not require a flat cover plate in order to block off an unused port.

FIG. 10 is a perspective view of the right side of an automobile engine with the present invention installed over an unused fuel pump port, illustrating the relative position of the cover box and engine.

FIG. 11 is a detail front view of the cover box of the present invention shown installed on the same engine as shown in FIG. 10, illustrating how the hexagonal shape of the outer surface of the cover box of the present invention allows the upper left corner of the cover box to clear the front edge of the cylinder head of the engine.

FIG. 12 is a side view of the present invention that illustrates how the thickness of the cover box allows the decorative plate to clear the protruding edge of the cylinder head of the engine.

### REFERENCE NUMBERS

1 Decorative cover plate apparatus
2 Cover box, first embodiment
3 Decorative plate
4 Top attachment slot
5 Overhanging lip
6 Embossed design
7 Mounting bracket, first embodiment
8 Attachment screw
9 Flat cover plate
10 Attachment bolt
11 Upward-pointing top tab
12 Upward-pointing bottom tab
13 Bottom attachment slot
14 Pinch nut
15 Cover box, second embodiment
16 Mounting bracket, second embodiment
17 Downward-pointing top tab
18 horizontal bottom tab
19 Upper attachment bolt
20 Lower attachment bolt
21 Fuel pump port
22 Threaded receptacle
23 Automobile engine
24 Cylinder head
25 Front edge of cylinder head

### DETAILED DESCRIPTION OF INVENTION

The present invention is a metallic decorative apparatus for automotive engines that is designed to cover bolt heads and unused ports that are considered to be unsightly by many show car enthusiasts. The term “show cars” is loosely defined as automobiles that are modified and/or restored for display. In many cases, the engines of older show cars are replaced with larger and more modern engines that have been modified to Improve their appearance and performance. The display of show cars typically includes raising the hood of the vehicles so that the engine and other under-hood components may be viewed and compared with other vehicles in the show. Many show car engines leave unused parts that are covered with flat plates that are held in place by bolts that are threaded into the engine block. The appearance of a show car engine is considered to be improved when these flat plates and bolts are hidden from view by a decorative cover.

One common unused engine port in show cars is the mechanical fuel pump port. The fuel pump port was originally cast into the engine block during manufacture for the purpose of mounting a mechanical fuel pump, which was powered by a reciprocating lever arm that extended through the port into the engine block. As fuel pumps have become more advanced over the years, the original mechanical fuel pump is frequently replaced by an electrical fuel pump that does not require a mechanical connection to the interior of the engine block. When an engine is converted from mechanical to electrical fuel pump operation, the mechanical fuel pump is unbolted from the engine block and discarded, and a sealing cover plate is bolted over the port that was previously used to connect the mechanical fuel pump to the internal components of the engine that powered the pump.

Fuel pump ports may comprise one, two or four attachment bolt receptacles (threaded holes) for attaching the fuel pump. The present invention is compatible with all of these bolt-hole configurations and may be mounted using either one or two attachment bolts. For ports that utilize four attachment bolts, the present invention is attached using two of the existing bolts, and the mounting bracket of the present invention fits between the remaining two bolts, allowing the unused bolts to remain in place. For some engines of still more recent manufacture, the fuel pumps were eliminated and replaced by fuel injection systems. These types of engines typically comprise a single threaded mounting hole and do not require a sealing cover plate. The present invention can be installed on these types of engines by bolting the mounting bracket directly to the single threaded hole in the engine block, with no cover plate required.

The decorative plate of the present invention incorporates a visually appealing design that may be selected based on the preferences of the car owner. The present invention is designed so as to be compatible with a wide range of engine blocks that are commonly installed in show cars, including most large and small block Chevrolet engines, Chrysler 273-440 cubic-inch engines, and most Ford and Pontiac engines.

The present invention comprises three major components, that is, a mounting bracket, a cover box, and a decorative plate. The mounting bracket attaches the present invention to the engine block. The cover box encloses unsightly engine components and provides spatial clearance for installing the decorative plate. The decorative plate hides the cover box and provides enhanced visual appearance of the engine. All components of the present invention are comprised of metal in order to withstand high temperatures produced by the engine. The present invention has two embodiments; the difference between the embodiments is related to details of the attachment of the mounting bracket to the cover plate.

For applications in which the present invention is used to cover a flat sealing plate on an engine, the mounting bracket is attached to the flat sealing plate by removing the existing plate attachment bolt or bolts and bolting the bracket over the existing flat plate by passing the existing attachment bolt(s) through holes provided in the mounting bracket. For applications in which the present invention is used to cover parts of an engine block that comprise a bolt hole (or multiple bolt holes) but no sealing plate, the mounting bracket is attached to the engine by passing an attachment bolt through one of the holes in the mounting bracket and then tightening the bolt into the existing engine block bolt hole.

For both embodiments of the present invention, the mounting bracket is comprised of sheet metal, preferably steel or aluminum, and has an approximate thickness of 1/32-inch to 1/16inch. The mounting bracket is cut or stamped out in a general, “cross’ shape, comprising a generally rectangular vertical post with a horizontal arm extending from each side of the vertical post. The height of the vertical post is approximately 4½ inches, and the width of the arms is approximately 2⅞ inches from tip to tip. Each arm comprises one cut or stamped hole approximately ⅜ inch in diameter. The two holes are symmetrically positioned on the horizontal centerline of the arms, with a center-to-center hole spacing of approximately 1¾ inch. The arms are positioned with respect to the vertical post so that the horizontal centerline of the horizontal arms perpendicularly intersects the vertical centerline of the vertical post, at a point on the vertical post centerline that is between the middle and the top of the vertical post. In addition, both embodiments of the mounting bracket comprise a top tab and a bottom tab, although the shapes of the tabs differ in the two embodiments.

In the first embodiment, the top tab is formed by a first 90-degree bend (in the direction toward the back side of the cover box) that produces a horizontal portion approximately ⅜-inch long, and a second 90-degree bend that forms an upward-pointing tip having a length of approximately ⅛-inch. In the first embodiment, the bottom tab is formed by a first 90-degree bend (in the direction toward the back side of the cover box) that produces a horizontal portion approximately ½-inch long, and a second 90-degree bead that forms an upward-pointing tip having a length of approximately ½-inch.

In the second embodiment, the top tab is formed by a first 90-degree bend (in the direction toward the back side of the cover box) that produces a horizontal portion approximately ¼-inch long, and a second 90-degree bend that forms a downward-pointing tip having a length of approximately ¼-inch. In the second embodiment, the bottom tab is formed by a single 90-degree bend (in the direction toward the back side of the cover box) that produces a horizontal portion approximately ½-inch long. Both embodiments of the mounting brackets comprise a hole having a diameter of approximately 3/16-inch that is installed in the horizontal portion of the bottom tab.

The cover box of the present invention is preferably hexagonal in shape, which eliminates protruding corners that would otherwise come into contact with adjacent engine parts (for example, the cylinder head). The cover box is manufactured to have sufficient depth (for example, ¾ inch) so that the decorative plate will clear adjacent engine parts; because of this configuration, the decorative plate can be made larger in height and width than the cover box, thereby increasing the surface area available for the decorative design. The cover box and decorative plate are permanently bonded together, such as by welding, riveting or soldering. The cover box/decorative plate assembly is designed so that it can be attached to the mounting bracket from the underside of the engine after the mounting bracket has been bolted onto the flat cover plate.

In the first embodiment of the present invention, the cover box/decorative plate assembly snaps onto the mounting bracket via the upward-pointing top tab on the mounting bracket that fits into a slot in the top of the cover box and the upward-pointing bottom tab on the mounting bracket that fits into a slot in the bottom of the cover plate. In the second embodiment of the present invention, the cover box/decorative plate assembly snaps onto the mounting bracket via the downward-pointing top tab on the mounting bracket that fits into a top slot of the cover box. For both embodiments, a screw is used to secure the bottom of the mounting bracket to the bottom of the cover box, by inserting the screw through a hole in the bottom of the cover box and a corresponding hole in the horizontal portion of the bottom tab of the mounting bracket. An optional pinch nut may be installed on the inside surface of the cover box (first embodiment) or the bottom tab of the mounting bracket (second embodiment) to provide a stronger attachment for the screw threads.

For both embodiments, the cover box/decorative plate assembly may be easily removed and replaced with another cover box/decorative plate assembly by simply removing the screw, unsnapping the old cover box/decorative plate assembly, snapping a new cover box/decorative plate assembly into place on the mounting bracket, and replacing the screw. The ability to easily interchange the cover box/decorative plate assembly is useful for providing a change of decorative designs as desired by the owner.

Although the present invention has been optimized for the purpose of providing a decorative cover for unused fuel pump ports, the present invention may be used as a variety of applications and may be mounted on almost any flat surface as a decorative cover, as long as at least one bolt hole is present or can be installed.

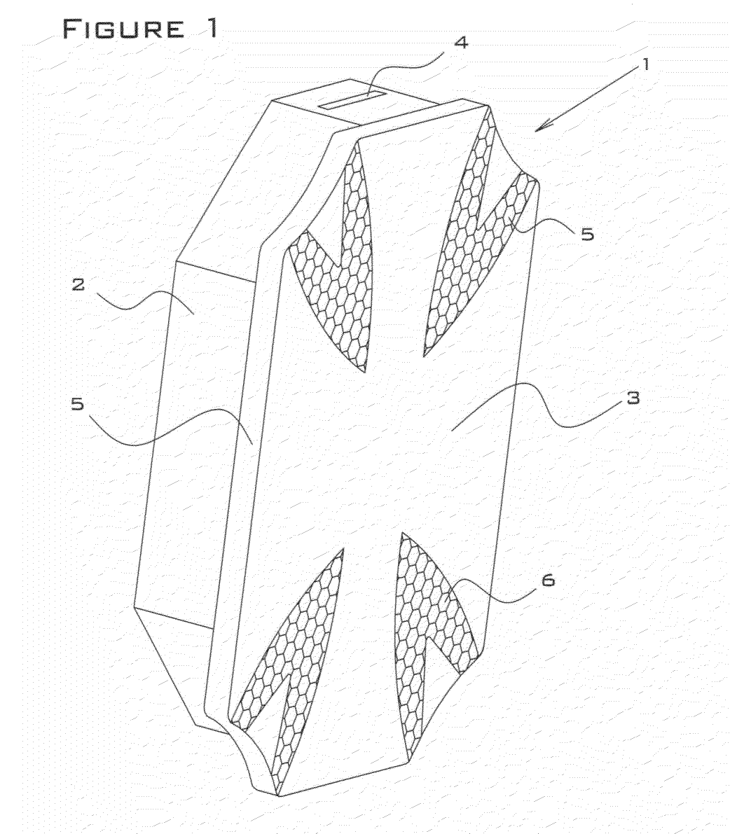

FIG. 1 is a perspective view of an assembled example of the first embodiment of the present invention 1, which is a decorative cover plate apparatus. Major components shown in FIG. 1 include the first embodiment cover box 2 and the decorative plate 3. The cover box 2 comprises a top attachment slot 4. The decorative plate 3 comprises an overlapping lip 5 and embossed designs 6. The purpose of the overhanging lip 5 is to help hide the cover box 2 from view when the invention is viewed from an angle other than perpendicular to the plane of the decorative plate 3. The embossed designs 6 shown in FIG. 1 are stylized representations of Indian arrowheads, but any design acceptable to the car owner may be substituted. The cover box 2 has an open back and is preferably constructed from stamped sheet metal. The decorative plate 3 is preferably constructed from ¼-inch thick plate metal (for example, aluminum) that is milled, cast, or stamped. The decorative designs are machined or otherwise embossed onto the outer face of the decorative plate. The width of the decorative plate is at least as wide as the width of the cover box, and the height of the decorative plate is at least as high as the height of the cover box so that the decorative plate covers the front surface of the cover box completely.

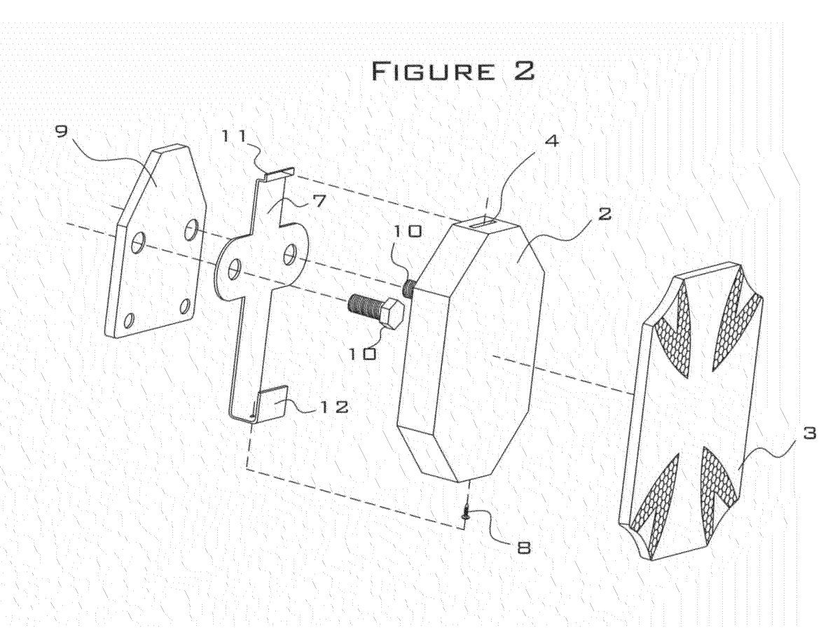

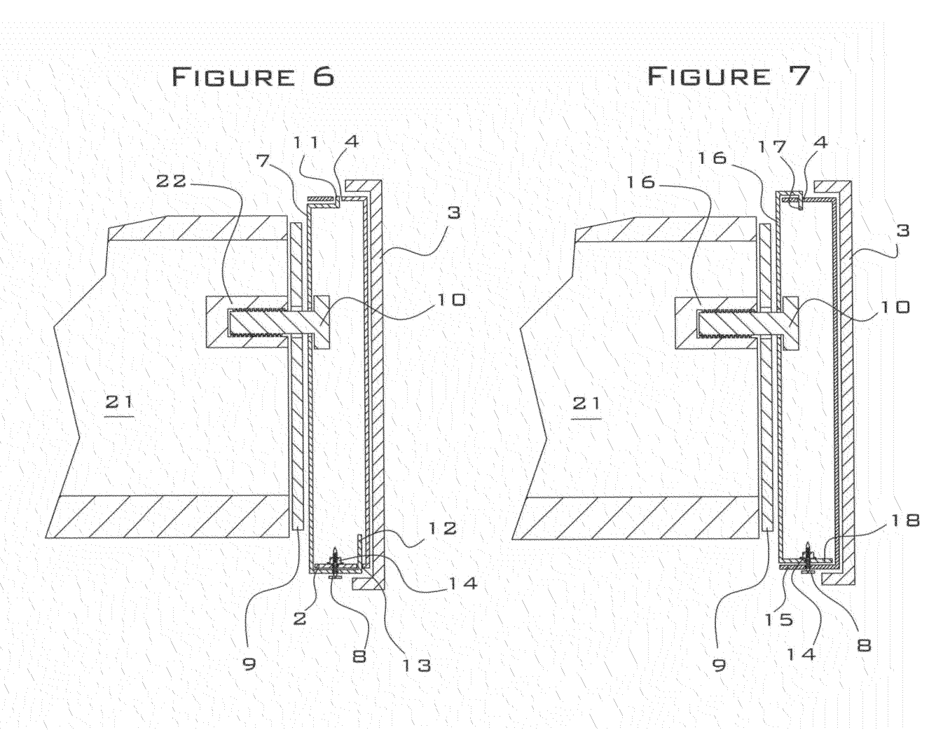

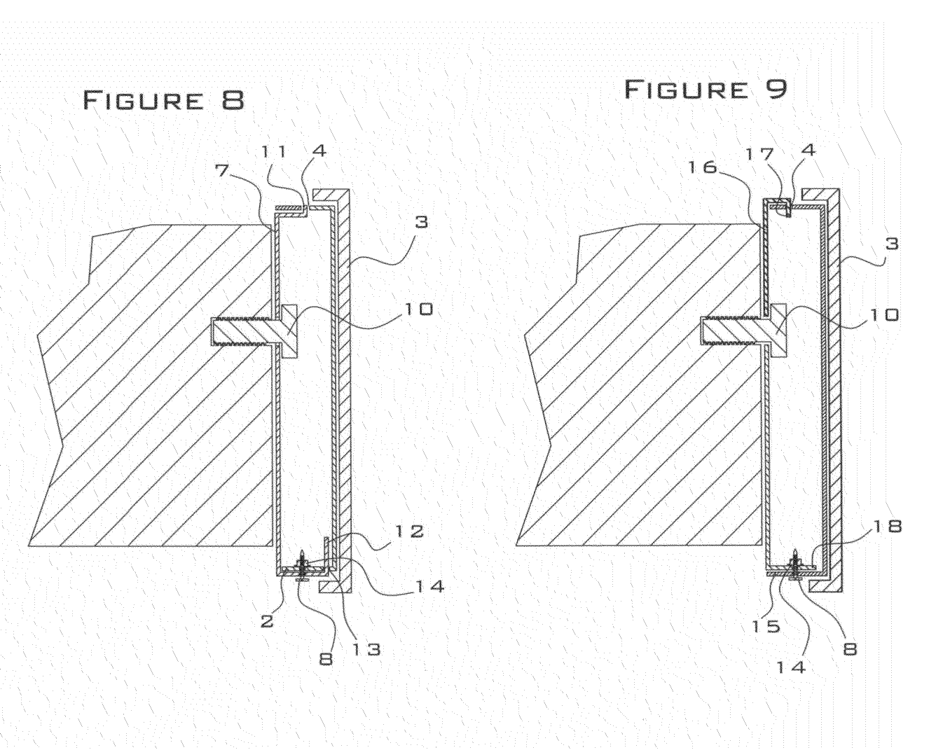

FIG. 2 is an exploded perspective view of the first embodiment of the present invention, showing the first embodiment cover box 2, the decorative plate 3, the first embodiment mounting bracket 7, and the attachment screw 8. Also shown are the related existing engine components, including the flat cover plate 9 and the attachment bolts 10. When the apparatus is assembled and mounted to an engine, the mounting bracket 7 fits flush against the flat plate 9, as shown in the following FIGS. 6, 8 and 12, and the cover box 2 fits onto the mounting bracket 7, so that the upward-pointing top tab 11 of the mounting bracket 7 snaps into the top attachment slot 4 of the cover box 2, while the upward-pointing bottom tab 12 of the mounting bracket 7 snaps through the bottom attachment slot 13 (as shown in following FIGS. 6 and 8) of the cover box 2. A screw 8 is threaded through holes in the bottom of the mounting bracket 7 and the cover box 2 to ensure that these two parts remain securely attached to each other. An optional pinch nut 14 (shown in following FIGS. 6 and 8) may be fused to the inside of the bottom surface of the cover box 2 in order to help lock the screw 8 in place. The heads of the bolts 10 are enclosed within the interior of the cover box 2 and are, therefore, hidden from sight. As previously described, the decorative plate 3 is permanently attached to the cover box 2 by welding or other means.

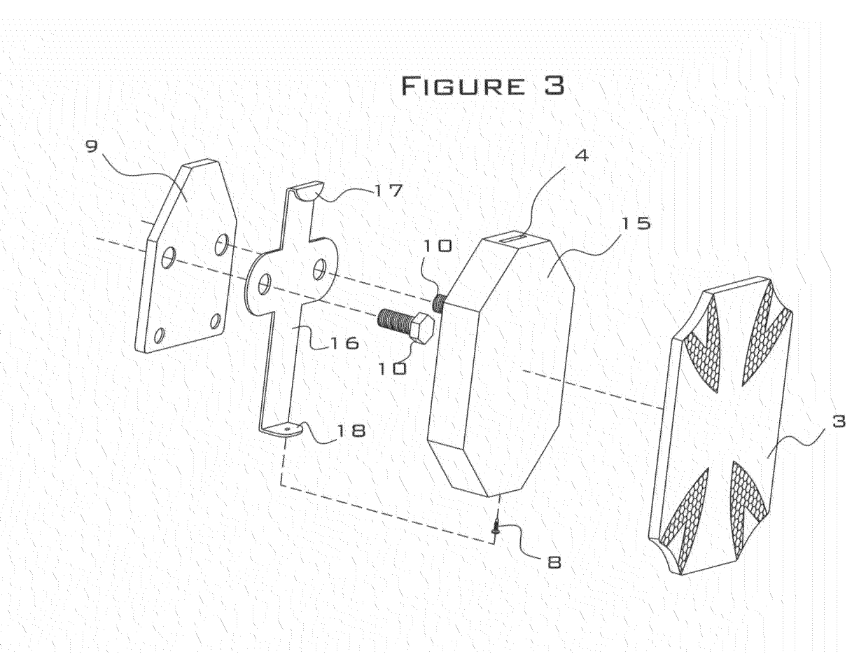

FIG. 3 is an exploded perspective view of the second embodiment of the invention, showing the second embodiment cover box 15, the decorative plate 3, the second embodiment mounting bracket 16, and the attachment screw 8. Also shown are the related existing engine components, including the flat cover plate 9 and the attachment bolts 10. When the apparatus is assembled and mounted to an engine, the mounting bracket 16 fits flush against the flat plate 9, as shown in the following FIGS. 7 and 9, and the cover box 15 fits onto the mounting bracket 16, so that the downward-pointing top tab 17 of the mounting bracket 16 snaps into the top attachment slot 4 of the cover box 15, while the horizontal bottom tab 18 of the mounting bracket 16 fits inside the bottom surface of the cover box 15. A screw 8 is threaded through holes in the horizontal tab lower tab 18 of the mounting bracket 16 and the bottom of the cover box 15 to ensure that these two parts remain securely attached to each other. An optional pinch nut 14 (shown in following FIGS. 7 and 9) may be fused to the inside of the bottom surface of the cover box 15 in order to help lock the screw 8 in place.

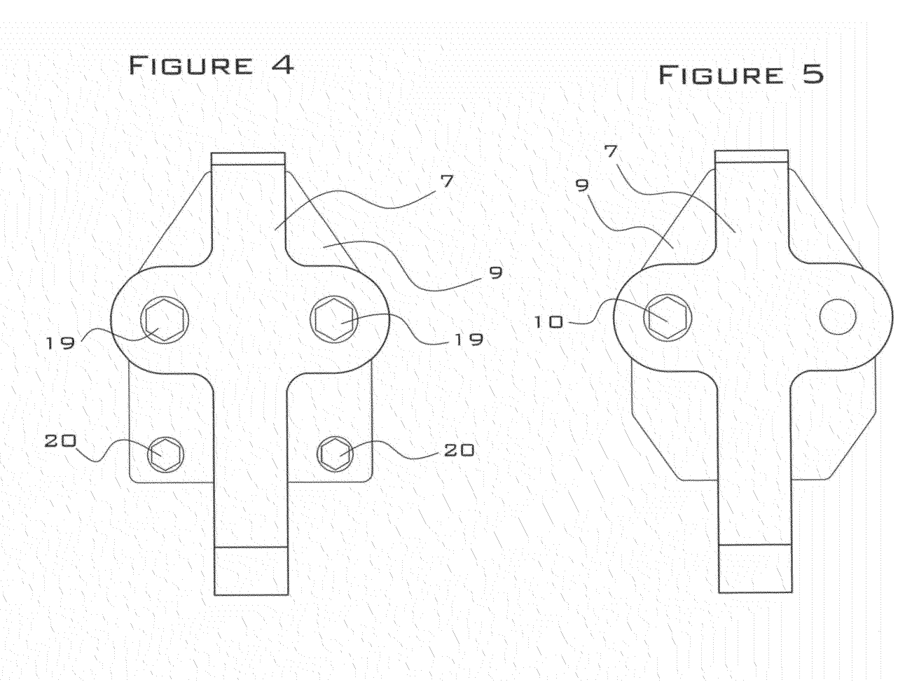

FIG. 4 is a front view of a first embodiment mounting bracket 7 attached to a flat cover plate 9 that is normally held in place by four attachment bolts. As shown, the mounting bracket 7 is attached to the two upper attachment bolts 19, while the narrow lower portion of the mounting bracket 7 fits between the two lower attachment bolts 20. In an alternate installation (not shown), the mounting bracket 7 may be attached to the two lower attachment bolts 20, while leaving the two upper attachment bolts 19 in place.

FIG. 5 is a front view of a first embodiment mounting bracket 7 attached to a flat cover plate 9 that is held in place by a single attachment bolt 10. FIGS. 4 and 5 illustrate that the present invention is compatible with a wide variety of cover plate and attachment bolt configurations. The mounting bracket of the second embodiment 16 (not shown in FIGS. 4 and 5) attaches to the engine components identically to the configurations illustrated in FIGS. 4 and 5 for the first embodiment mounting bracket 7.

FIG. 6 is a cross-section side view of the first embodiment of the invention shown attached to an unused fuel pump port 21 that has been blocked off by a flat plate 9. In this embodiment, the mounting bracket 7 is attached to one or more threaded receptacles 22 by one or more attachment bolts 10. The attachment bolts 10 used to attach the mounting bracket 7 are the same bolts that were previously used to attach the flat plate 9 over the unused fuel pump port 21. The existing flat plate 9 remains in its previous position to seal the entrance of the port 21. The cover box 2 is attached to the mounting bracket 2 by means of an upward-pointed top tab 11 on the mounting bracket 7 that is inserted through a top attachment slot 4 in the top of the cover box 2 and an upward-pointing bottom tab 12 that is inserted through a bottom attachment slot 13 in the bottom of the cover box 2. The attachment of the cover box 2 to the mounting bracket 7 is secured by a screw 8 that is threaded through a pre-punched hole (not shown) in the bottom surface of the cover box 2 and a matching pre-punched hole (not shown) in the bottom surface of the mounting bracket 7. An optional pinch not 14 may be fused to the inside bottom surface of the cover box 2 and used as extra support for the screw 8, as shown. When the present invention is installed as shown in FIG. 6, the flat plate 9 and the bolt(s) 10 are hidden from view.

FIG. 7 is a cross-section side view of the second embodiment of the present invention shown attached to an unused fuel pump port 21 that has been blocked off by a flat plate 9. In the second embodiment, the cover box 15 is attached to the mounting bracket 16 by means of a downward-pointing top tab 17 that is inserted through the top attachment slot 4 in the top of the cover box 15. The attachment of the cover box 15 to the mounting bracket 16 is secured by a screw 8 that is threaded through a pre-punched hole (not shown) in the bottom surface of the cover box 15 and a matching pre-punched hole (not shown) in the horizontal lower tab 18 of the mounting bracket 16. An optional pinch nut 14 may be fused to the inside bottom surface of the mounting bracket 16 and used as extra support for the screw 8 as shown. When the present invention is installed as shown in FIG. 7, the flat plate 9 and the bolt(s) 10 are hidden from view.

FIGS. 8 and 9 are cross-section side views of are first and second embodiments of the present invention, respectively, shown attached to a portion of the engine block that does not require a flat plate 9 in order to block off an unused port. Except for the flat plate 9 shown in FIGS. 6 and 7, the mounting and assembly of the first and second embodiments of the present invention shown in FIGS. 8 and 9 are identical to those shown in FIGS. 6 and 7.

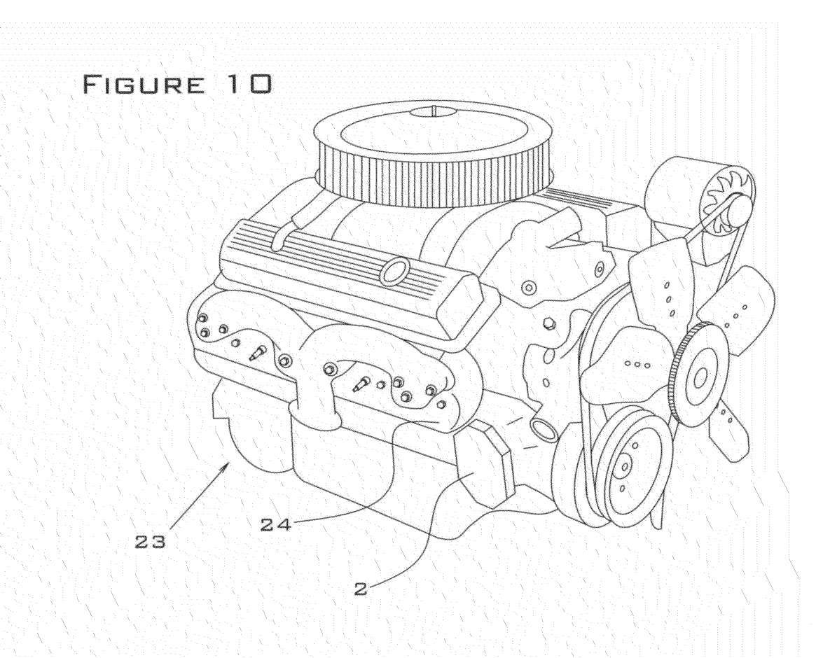

FIG. 10 is a perspective view of the right side of an automobile engine 23 with the cover box 2 of the present invention installed over an unused fuel pump port, illustrating the relative position of the cover box 2 on the engine 23, just forward of the cylinder bead 24. As shown, the cover box 2 effectively hides the flat plate and attachment bolts of the unused fuel pump port from view.

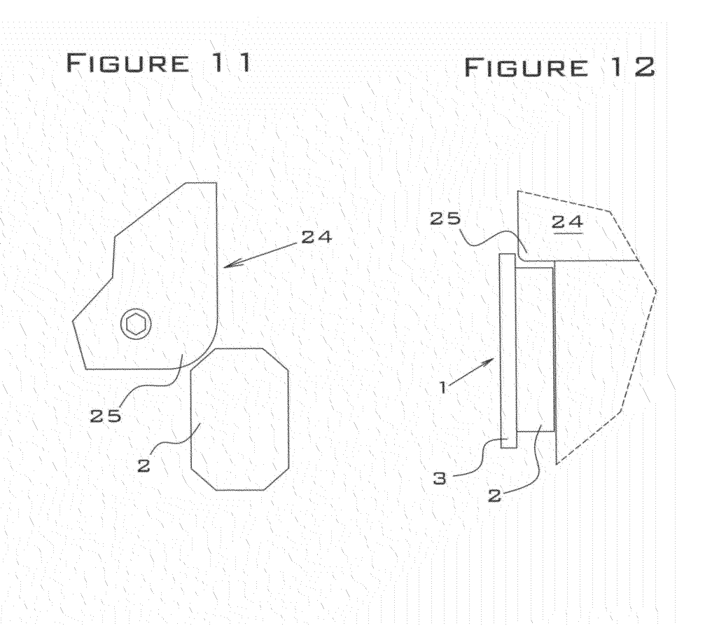

FIG. 11 is a front view of the cover box 2 shown installed on the same engine as shown in FIG. 10. FIG. 11 illustrates how the hexagonal shape of the cover box 2 allows the upper left corner of the cover box 2 to clear the front edge 25 of the cylinder head 24.

FIG. 12 is a side view of the present invention 1 shown installed on the same engine as shown in FIG. 10. FIG. 12 illustrates how the depth of the cover box 2 allows the decorative plate 3 to be mounted at a location that does not interfere with the protruding front edge 25 of the cylinder head 24.

Although the preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

1. A decorative cover plate apparatus comprising:
(a) a mounting bracket having a right side and a left side, comprising a vertical post and a horizontal arm extending from the right side and a horizontal arm extending from the left side, each horizontal arm having a center, and each horizontal arm having an aperture in roughly the center of the horizontal arm, the vertical post having a middle, a top, and a vertical centerline, each of the horizontal arms having a horizontal centerline, wherein the horizontal centerline of the horizontal arms intersects the vertical centerline of the vertical post perpendicularly at a point on the vertical post centerline that is between the middle and the top of the vertical post, the mounting bracket further comprising a top tab and a bottom tab;
(b) a cover box comprising a top attachment slot and having an open back; and
(c) a decorative plate comprising an overhanging lip, the decorative plate being at least as wide as the cover box and at least as high as the cover box;
wherein the top tab of the mounting bracket fits into the top attachment slot on the cover box.

2. The decorative cover plate apparatus of claim 1, wherein the top tab of the mounting bracket is formed by a first ninety-degree bend that produces a horizontal portion and a second ninety-degree bend that forms an upward-pointing tip, and wherein the bottom tab of the mounting bracket is formed by a first ninety-degree bend that produces a horizontal portion and a second ninety-degree bend that forms an upward-pointing tip, and wherein the horizontal portion of the bottom tab comprises a hole.

3. The decorative plate apparatus of claim 2, wherein the upward-pointing tip of the bottom tab of the mounting bracket fits into a bottom attachment slot on the cover box.

4. The decorative cover plate apparatus of claim 1, wherein the top tab is formed by a first ninety-degree bend that produces a horizontal portion and a second ninety-degree bend that forms a downward-pointing tip, and the bottom tab of the mounting bracket is formed by a ninety-degree bend that produces a horizontal portion, and wherein the horizontal portion of the bottom tab comprises a hole.

5. The decorative plate apparatus of claim 4, the cover box having a bottom surface, wherein the horizontal portion of the bottom tab of the mounting bracket fits inside the bottom surface of the cover box.

6. The decorative cover plate apparatus of claim 1, wherein the cover box is octagonal in shape.

7. The decorative cover plate apparatus of claim 1, wherein the cover box has a depth of at least ¾-inch.

8. The decorative cover plate apparatus of claim 1, wherein the cover box and decorative plate are permanently bonded together.

9. The decorative plate apparatus of claim 1, wherein the decorative plate further comprises an embossed design.

10. The decorative plate apparatus of claim 2 or 4, the cover box having a bottom surface with a hole that is situated so as to align with the hole in the horizontal portion of the bottom tab of the mounting bracket when the decorative plate apparatus is fully assembled.
